(19) United States
(12) Patent Application Publication
(10) Pub. No.: US 2006/0156249 A1
(43) Pub. Date: Jul. 13, 2006

(54) Rotate a user interface

(76) Inventors: Michael M. Blythe, Albany, OR (US); Matthew Ryan Bonner, Portland, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/033,602

(22) Filed: Jan. 12, 2005

(51) Int. Cl. G06F 3/00

(52) U.S. Cl. 715/781

(57) ABSTRACT

Systems, methods, and devices are provided for rotating selected ones of a plurality of user interfaces on a display without rotating unselected ones of the plurality of user interfaces.

In order to interact with the software of a computing device, many software programs, including operating systems and program applications, include a graphical user interface (GUI) functionality.

Program applications often use a GUI implementation called a window that represents an open work space allocated for with respect to that particular program application. In addition to a program allowing multiple windows to be used, an operating system can allow multiple windows from multiple application programs to be open on the display.

However, for these GUI implementations, multiple individuals have not been able to independently access application programs without having their own computing device.

### BRIEF DESCRIPTION OF THE DRAWINGS

FIG. 1A illustrates an embodiment of a display system.

FIG. 1B illustrates an embodiment of a user interface.

FIG. 2 illustrates a block diagram of the component of a display system embodiment.

FIG. 3A illustrates another embodiment of a user interface on the display system of FIG. 1A.

FIG. 3B illustrates another embodiment of a display system.

FIG. 4A illustrates another embodiment of a display system.

FIG. 4B illustrates another embodiment of a display system.

FIG. 5A illustrates another embodiment of a user interface.

FIG. 5B illustrates another embodiment of a user interface.

### DETAILED DESCRIPTION

Embodiments disclosed herein provide methods, systems, and devices to rotate one or more selected user interfaces of a plurality of user interfaces. In such embodiments, the selected user interfaces can be rotated without rotating unselected ones of the plurality of user interfaces. System embodiments of the present disclosure include a display for displaying a number of user interfaces and a computing device that includes memory having computer executable instructions to provide the number of user interfaces on the display.

In various embodiments, the computing device can also include computer executable instructions stored in memory and executable on a processor to provide one or more users the ability to use each of the number of user interfaces. In some embodiments, the computer executable instructions can provide a rotation tool associated with a particular user interface within the number of user interfaces. In such embodiments, manipulating the rotation tool can provide the ability to adjust the particular user interface associated with the rotation tool.

Device embodiments of the present disclosure include, among other things, I/O components for activating and manipulating a rotation tool associated with a particular user interface. And, method embodiments of the present disclosure include rotating one or more of the number of user interfaces any number of degrees in a clockwise and/or counter-clockwise direction, among other directions.

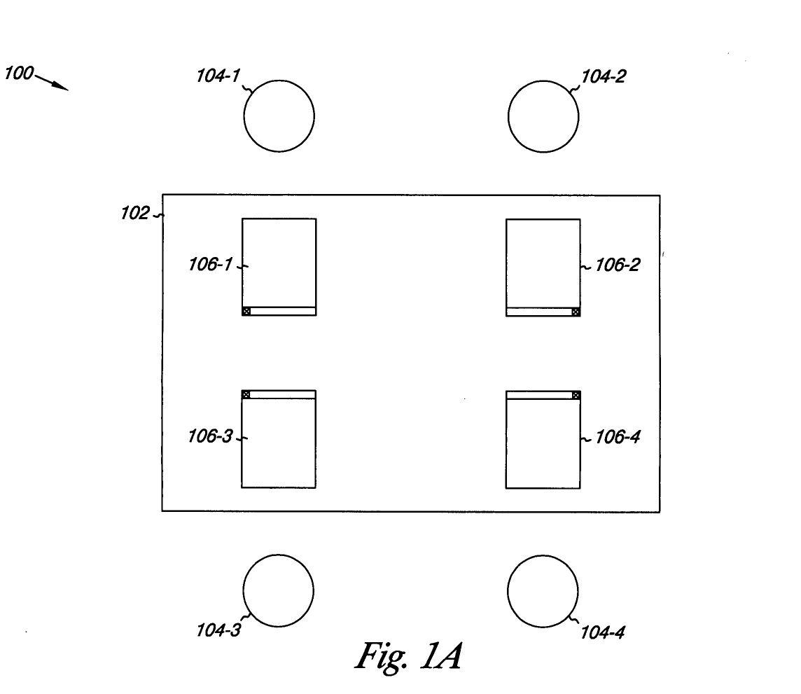

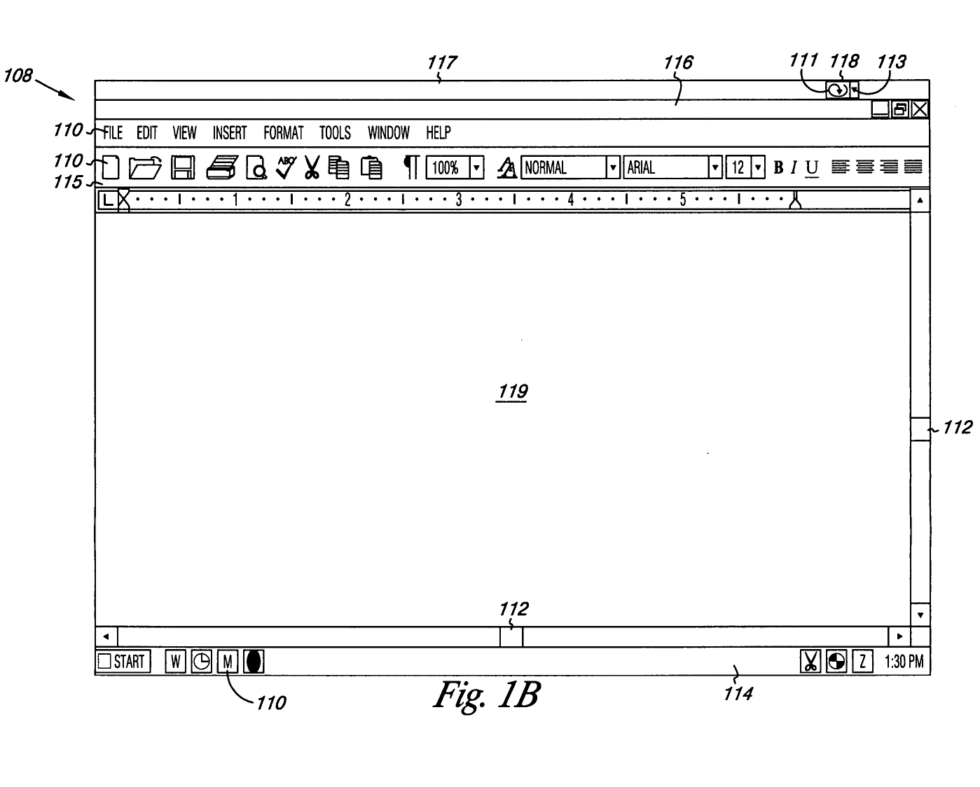

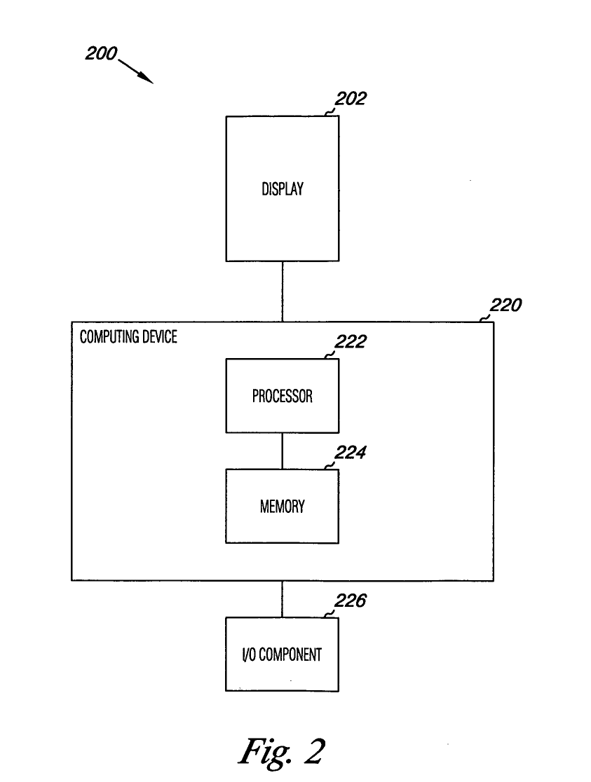

The figures herein follow a numbering convention in which the first digit or digits correspond to the drawing figure number and the remaining digits identify an element in the drawing. Similar elements between different figures may be identified by the use of similar digits. For example, 102 may reference element “102” in FIG. 1, and a similar element may be referenced as 202 in FIG. 2A. As will be appreciated, elements shown in the various embodiments herein can be added, exchanged, and/or eliminated so as to provide a number of additional embodiments.

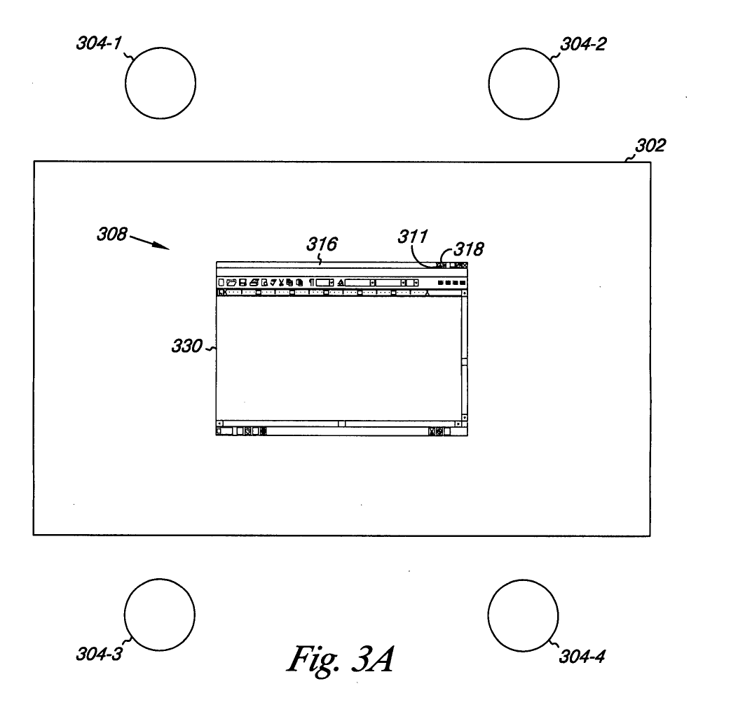

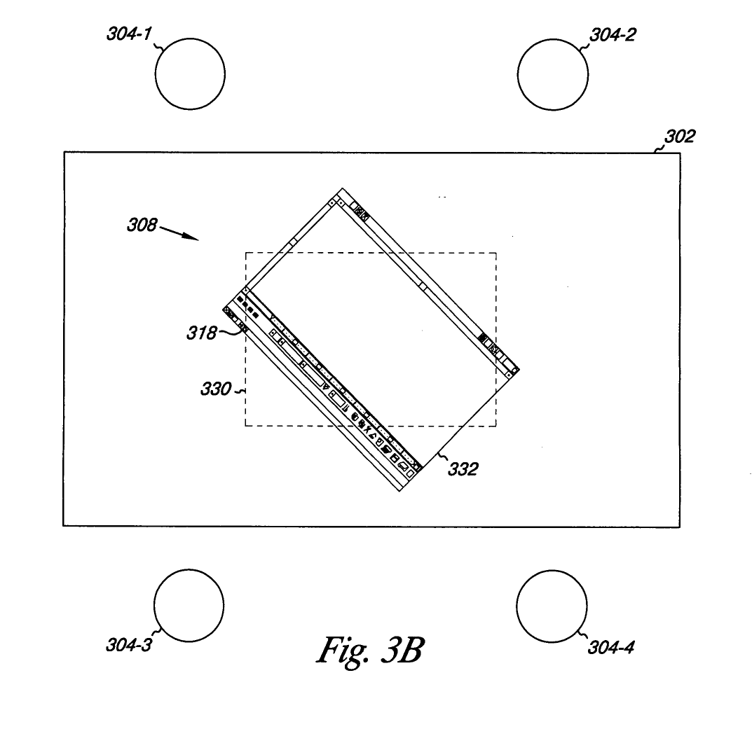

FIG. 1 illustrates an embodiment of a display system. The display system 100 includes a display 102. The display can be any suitable type of display for displaying images and/or text. For example, display types include, but are not limited to, active and passive liquid crystal displays, and front and rear projection active and passive displays, among others. In some embodiments, the display 102 can be a touch screen display, as will be discussed more fully below with regard to FIG. 3.

The display can provide a number of user interfaces for access by a number of users. For example, in the embodiment illustrated in FIG. 1A, four independent user interfaces 106-1, 106-2, 106-3, and 106-4 are provided on the display 102. In various embodiments, user interfaces can include, but are not limited to, application windows, web browser applications, word processing applications, email utilities, gaming applications, and the like. User interfaces will be described more fully below with regard to FIG. 1B.

In various embodiments, the display can be oriented in a number of ways. In some embodiments, the display can be oriented such that the surface of the display is facing upward and a plane of the display is positioned horizontally relative to a number of users. Positioning the display in such a manner can allow a number of users to position themselves along a perimeter of the display. For example, in the embodiment illustrated in FIG. 1A, four users 104-1 to 104-4 are illustrated as being positioned along the perimeter of the display 102, with the display surface positioned upwardly and horizontally relative to the four users 104-1 to 104-4.

FIG. 1B illustrates an embodiment of a user interface. As used herein, a user interface provides the ability for a user to interact independently with the display system of the present disclosure. In various embodiments, one or more of the number of user interfaces can include a graphical user interface (GUI). A GUI utilizes graphics to make a user interface easier to use. FIG. 1B illustrates an example of an embodiment of the present disclosure that includes a GUI.

The user interface 108, illustrated as a GUI in FIG. 1B includes a number of icons 110, scroll bars 112, a task bar 114, a tool bar 115, an application window 116, and a user interface bar 117, among other things. In addition, the user interface 108 includes an embodiment of a rotation tool, such as rotation tool 118. The rotation tool 118 can be positioned anywhere on the user interface. For example, in the embodiment illustrated in FIG. 1B, the rotation tool 118 is positioned at the top of the user interface 108 on the user interface bar 117 of the user interface 108. The rotation tool 118 can provide the ability for a user to rotate a particular user interface, such as a GUI, that is associated with the rotation tool 118, as will be discussed below with regard to FIGS. 3A and 3B.

The user interface 108 can also include an application window 116. The application window 116 can include a display window 119 in which the user can interact with a display of an application provided within the application window 116. In various embodiments, the application window 116 can be positioned at various locations on the user interface 108. As shown in FIG. 1B, for example, the application window 119 can be positioned above the task bar 114.

The application window 116 can include various icons and menus for providing functionality to the user interface 108 and interaction between the user interface 108 and a user. For example, the application window 116 can include a close window icon for closing the user interface 108 when a user has completed using the user interface.

The application window can also include a number of tool bars 115 including a number of selectable icons thereon. The one or more tool bars 115 can be positioned at various locations on the user interface 108. As shown in FIG. 1B, the tool bars 115 are positioned above the display window 119 and below the user interface bar 117.

Like the application window described above, the tool bars 115 can include various icons and menus for providing functionality to the user interface and interaction between the user interface and a user. For example, in some embodiments, the tool bars 115 can include various icons for editing documents, opening documents, and saving documents, among others.

The task bar 114 can include a start menu for opening various application programs, e.g., a Microsoft word document. The taskbar 114 can also include a number of icons for controlling the functions of an application program.

The user interface 108 can include other types of functionality. In some embodiments, for example, a number of scroll bars 112 can be provided. The scroll bars 112 can be used to adjust the display window in a number of directions. For example, the scroll bars 112 can be used to adjust the display window up, down, left, and right.

As shown in FIG. 1B, the user interface 108 includes a rotation tool 118. The rotation tool 118 is illustrated as an icon positioned at the top of the GUI 108 in a user interface window 117 of the user interface 108. However, in various embodiments, the rotation tool can be positioned at any location of the user interface 108 and can be represented in various forms as discussed below.

For example, the rotation tool 118 shown in FIG. 1B includes a rotational symbol 111. In various embodiments, the rotational symbol 111 can function as a visual indicator for a user to identify the rotation tool 118 on the user interface 108 and can be presented in various forms as discussed below. In various embodiments, the rotational symbol 111 can include any suitable symbol, text, colors, and the like, as a visual indicator of the rotation tool 118, and is not limited to any particular visual indicator described herein.

In the embodiment shown in FIG. 1B, the icon includes a button and a pull down menu. The icon can also include one or more symbols to represent the functions of the rotation tool 118 to the user. For example, the swirling symbol 111 indicates to the user that the button 111 is for rotating the user interface 108. The arrow on button 113 indicates that the button activates a pull down menu associated with the rotation of the user interface. In addition, the rotation tool 118 includes an arrow 113.

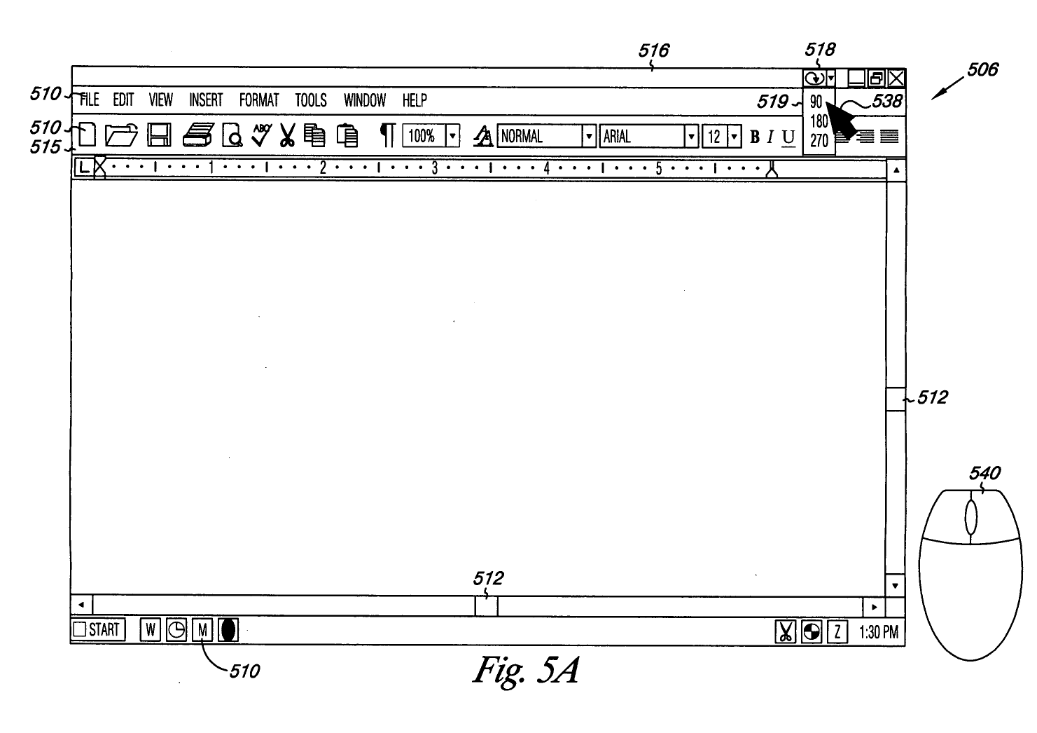

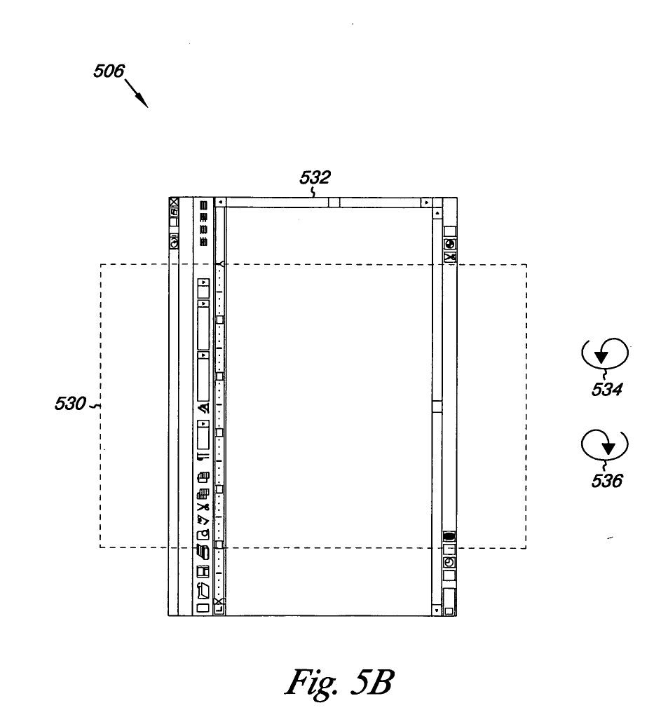

In various embodiments, the pull-down menu includes items that represent predetermined degrees of rotation, as will be discussed with regard to FIG. 5A. In some embodiments, the icon can be a dialogue box for a user to enter a specific degree of rotation.

The rotation tool 118 can rotate a user interface based on activating the rotation tool 118 and/or manipulating the rotation tool 118. In various embodiments, the rotation tool 118 can be manipulated to adjust a particular user interface (e.g., a GUI) that is associated with the particular rotation tool.

The adjustment of the particular user interface can include rotating the particular user interface that is associated with the particular rotation tool. For example, adjusting the user interface can provide a user with an ability to rotate the user interface from a first orientation to a second orientation. In this way, the rotation of the user interface from a first to a second orientation can provide a way for a number of users to view and/or interact with a particular user interface, as will be discussed below with regard to FIG. 3B.

The activation of a rotation tool associated with a particular user interface can be accomplished in a variety of ways. As used herein, activating a rotation tool includes making the rotation tool active such that it can be manipulated to rotate a particular user interface associated with the rotation tool.

For example, activating a rotation tool can cause a pull-down menu to appear on the display. In such embodiments, the activated rotation tool can be manipulated to rotate a particular user interface associated with the rotation tool. For example, with respect to a pull-down menu type of rotation tool, the manipulation can be accomplished by choosing a degree of rotation from the pull-down menu.

In other embodiments, activating the rotation tool can include activating a window associated with a particular user interface. For example, in some embodiments, the window that is activated is an application window within a particular user interface. In such embodiments, activating the rotation tool can include selecting the application window with a cursor controlled by an I/O component. Once selected, the application window, acting as the rotation tool, can be manipulated using the I/O component, as will be described below with respect to FIGS. 5A and 5B.

In some embodiments, activating the rotation tool can include contacting a surface of the display at a location corresponding to the position of the rotation tool on the display. In such embodiments, the display can include a touch screen display, such that contacting the surface of the touch screen can activate the rotation tool. Contacting the surface of the touch screen can be accomplished, for example, through use of a stylus, a mouse type component or other physical object (e.g., a token) and/or a finger, among other items.

As used herein, manipulating a rotation tool includes causing a particular user interface to rotate based upon an interaction by a user with a particular rotation tool that is associated with the particular user interface. For example, manipulating the rotation tool can include selecting a degree of rotation from a number of preset values. In some embodiments, preset values can include degrees of rotation, e.g., 90 degrees, 180 degrees, among others.

In other embodiments, manipulating the rotation tool can include entering a specific degree of rotation. For example, the entering of a specific degree of rotation can be accomplished by entering a specific degree of rotation, or other information, using an I/O component such as a numerical keypad or keyboard. And, in some embodiments, manipulating the activated rotation tool can include dragging a particular user interface using a cursor controlled by an I/O component to rotate the user interface, as will be discussed with respect to FIGS. 5A and 5B.

FIG. 2 illustrates a block diagram of the components of a display system embodiment. The display system 200 includes a display 202, as for example, the display 102 illustrated in FIG. 1. The display system 200 can also include a computing device 220. The computing device can be coupled to the display in a variety of ways. For example, the display system 200 can be configured such that communication between the computing device 220 and the display 202 can be carried out using a wireless, wired, or combination of wired and wireless connections.

As illustrated in FIG. 2, the computing device 220 includes a processor 222 and memory 224. The computing device 220 can provide a number of functionalities of the display system 200. For example, computer executable instructions stored in memory 224 and executable on the processor 222 can provide for a number of user interfaces to be displayed on the display 202. A processor can, for example, execute computer executable instructions stored in memory 224 for providing a user interface, such as the GUI, described above in FIG. 1B. In such embodiments, by providing a number of user interfaces on the display, each of the user interfaces can be used by a different user.

Computer executable instructions stored in memory and executable on the processor allow for the one or more users to view and/or interact with the number of user interfaces. For example, in some embodiments, two or more users can interact with two or more user interfaces, where each user interacts with a particular user interface.

Computer executable instructions also provide for the presentation and operation of a number of application program windows within the one or more user interfaces. For example, one user can interact with a user interface having a word processing application program, while a different user interacts and/or views a different user interface having a web browser to surf the internet.

Additionally, a user interface can have multiple application programs displayed within the user interface. In such embodiments, a user can activate an application program to use, such as by selecting a particular application window or the display window with I/O component 226 for example. And, in various embodiments, computer executable instructions stored in memory and executable on the processor can provide a rotation tool associated with each of the number of user interfaces and provide the functionality of the rotation tool, as will be discussed more thoroughly below with regard to FIGS. 3A-3B. Computer executable instructions stored in memory and executable on the processor can include instructions executable for rotating a particular user interface associated with the rotation tool.

In various embodiments, the processor executes computer executable instructions e.g., software, stored in memory. The embodiments of the present disclosure, however, are not limited to a specific type or number of processors or to any particular type or amount of memory and are not limited to where within a device or display system these components or a set of computer instructions reside for use in implementing the various embodiments of present disclosure.

Memory can be used, for example, to store the computer executable instructions and other information useful in providing computing device or system functions. Memory can include various volatile and non-volatile memory types, such as ROM, RAM, and flash memory, for example.

FIG. 3A illustrates another embodiment of a user interface. The user interface illustrated in FIG. 3A includes a GUI 308 displayed on the display 302 generated by a computing device, such as the computing device 220 illustrated above in FIG. 2.

As illustrated in FIG. 3A, the GUI 308 is positioned in a first orientation 330. In the first orientation 330, users 304-3 and 304-4 can view the GUI 308 in its intended orientation (e.g., top of the GUI oriented at the top of user's 304-3 and 304-4 field of view). With the GUI 308 in the first orientation 330, users 304-3 and 304-4 can use the GUI 308 to perform various tasks. For example, in the case of a word processing GUI, users 304-3 and/or 304-4 can create text and other documents by interacting with the GUI 308 on the display 302.

FIG. 3B illustrates another embodiment of a display system. In the embodiment shown in FIG. 3B, the GUI 308 is illustrated as being rotated from a first orientation 330, as described above in FIG. 3A, to a second orientation 332. In various embodiments, rotating a user interface, such as a GUI, from a first orientation to a second orientation can orient the user interface in a position more suitable for interaction by other users around the display. For example, in some situations, a display in a first orientation may provide a position more suitable for interaction and/or viewing of the GUI for some users due to those users' positions relative to the display, while other users may not be positioned in a location relative to the display that is suitable for viewing the particular user interface. In such a situation, rotating the GUI to a different orientation, such as to a second orientation can provide for the user interface to be more suitably positioned for interaction and/or viewing by other users.

For example, in FIG. 3B, a second orientation 332 is illustrated. The second orientation 332 provides user 304-2 with a more suitable way to interact and/or view the GUI 308, that when the user interface was positioned in the first orientation 330, which is indicated by dashed lines.

In various embodiments, the second orientation 332 can be achieved by manipulating the rotation tool 318. For example, in the case of a touch screen display, a user, such as user 304-3 or user 304-4 illustrated in FIG. 3A, can activate the rotation tool by contacting the display. For example, in some embodiments, a user's finger can be used to contact a surface of the touch screen display at a location corresponding to the position of the rotation tool on the touch screen display to activate the rotation tool. And, in other embodiments, a device such as a stylus, a cursor controlled by an I/O component, or other devices or components can be used to activate the rotation tool, such as based upon information received regarding the movement of the mouse, the clicking of a mouse button or keyboard key, or the movement of a wheel or ball, to name a few.

The user, such as user 304-3 or user 304-4 can also manipulate the rotation tool by selecting a degree of rotation, for example, from a pull-down menu that corresponds to a position of a user in which the user interface is to be oriented. As shown in FIG. 3B, the second orientation 332 provides user 304-2 a more suitable orientation to view the GUI 308. Thus, user 304-2 can remain positioned at their location around the display 302 without having to move in order to change their view of the GUI 308 on the display 302.

In some embodiments, computer executable instructions can be provided such that the entire display, including several user interfaces, can be rotated. For example, a rotation tool can be provided on the display that is not associated with a particular user interface. In such embodiments, one or more user interfaces can be rotated at the same time by manipulating the unassociated rotation tool such that user interfaces are rotated. In this way, a number of user interfaces that are being used by different users can be rotated together. Additionally, such embodiment would allow multiple interfaces used by an individual to be rotated together.

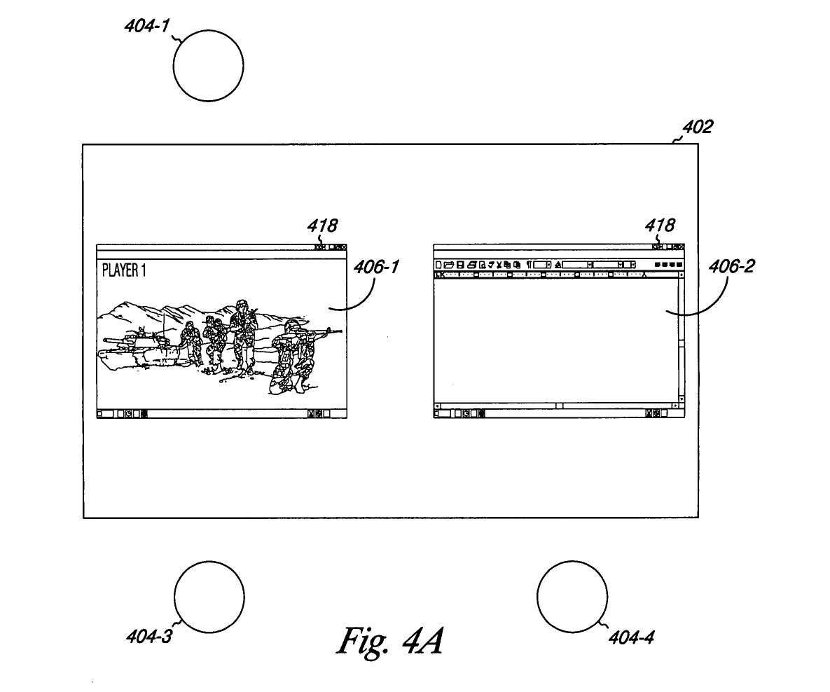

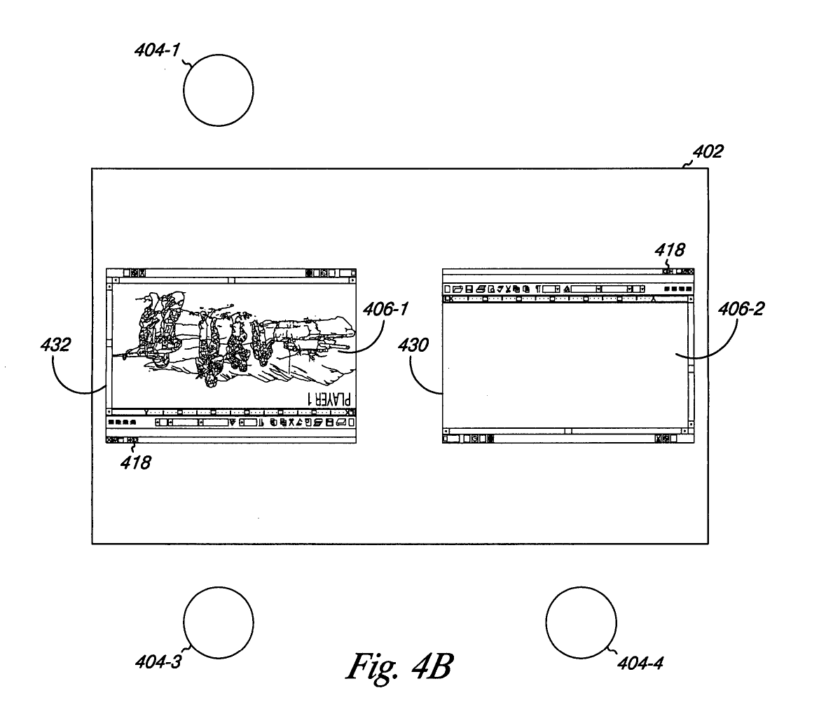

FIGS. 4A and 4B illustrate another embodiment of the display system of the present disclosure. In FIG. 4A, the display system includes a display 402 having two user interfaces 406-1 and 406-2. User interface 406-1 includes a gaming interface and user interface 406-2 includes a GUI. As shown in FIG. 4A, users 404-3 and 404-4 are positioned on a side of the display 402 opposite user 404-1.

As shown in FIG. 4A, the gaming interface 406-1 and the GUI 406-2 are positioned in a first orientation. The first orientation provides for interaction and/or viewing of the gaming interface 406-1 and GUI 406-2 by users 404-3 and 404-4. In such embodiments, user 404-3 can interact and/or view GUI 406-2 while user 404-4 can interact and/or view gaming interface 406-1. In the first orientation, user 404-1 is positioned at an opposite side of the display and thus, is viewing the user interface from an upside down perspective. Interacting with the user interfaces 406-1 and 406-2 in an upside down manner can be difficult.

In FIG. 4B, gaming interface 406-1 is positioned in a second orientation 432 and GUI 406-2 is positioned in the first orientation 430. As shown in FIG. 4B, the second orientation 432 is a result of the gaming interface 460-2 being rotated 180 degrees with respect to the first orientation 430 by the manipulation of rotation tool 418. By rotating the gaming interface 406-1 by 180 degrees from the first orientation 430 to the second orientation 432 the user 404-1 can interact and/or view the gaming interface 406-1 in a more suitable orientation. This functionality can be beneficial, for example, in a situation where user 404-4 has completed a playing turn on the gaming interface 406-1, and it is now a playing turn of user 404-1. In such embodiments, the rotation tool can be provided by computer executable instructions that are activated, for example, when a player's turn has ended, among other methods of activating the computer executable instructions.

FIGS. 5A-5B illustrate embodiments of a user interface. As discussed above, user interfaces can include a variety of interfaces such as a GUI, a gaming interface, and an application program interface, among others. In FIG. 5A, a GUI 506 is illustrated. The user interface 506, illustrated in FIG. 5A, includes a first orientation. The user interface 506 can also include various icons 510, scroll bars 512, a tool bar 515, an application window 516, and a rotation tool 518, etc.

The rotation tool 518, illustrated in FIG. 5A, includes a pull-down menu 519. Pull-down menus can provide various items that include, but are not limited to, predetermined degrees of rotation and dialogue boxes, among others. As shown in FIG. 5A, the rotation tool 518 includes a pull-down menu 519 having items that designate predetermined degrees of rotation. In various embodiments, the items on the pull-down menu 519 can provide a user with a choice of predetermined degrees to rotate the user interface 506. For example, as shown in FIG. 5A, items on the pull-down menu 519 include a 90, 180, and 270 degree of rotation. As shown in FIG. 5A, the item selected is a 90 degree rotation.

As discussed above with regard to FIGS. 3A and 3B, the rotation tool can be activated in a variety of ways. In the embodiment shown in FIG. 5A, the rotation tool 518 is activated by cursor 538, which is controlled by mouse 540. Mouse 540 can be used to activate the rotation tool 518 by selecting the rotation tool with the cursor 538. Activating the rotation tool 518 can be accomplished by using a cursor 538, for example, controlled with a mouse 540 to activate the pull-down menu 519 as illustrated in FIG. 5A. As shown in FIG. 5A, the cursor 538 is illustrated as manipulating the rotation tool 518 by selecting the item on the pull down menu 519 representing the 90 degree rotation.

In the embodiment shown in FIG. 5A, the pull-down menu includes predetermined degrees of rotation, e.g. 90, 180, and 270 degrees. In other embodiments, the degree of rotation can be selected by entering a specific degree of rotation. For example, in some embodiments, the pull-down menu can include a dialogue box for entering a specific degree of rotation, as for example a 20 degree rotation. For instance, in rotating a user interface 20 degrees, a specific degree of rotation value, e.g., the value 20, can be entered in the dialogue box. In this way, the user interface can rotate 20 degrees from a first orientation to a second orientation.

In some embodiments, rotating one or more user interfaces can include using one or more I/O components. For example, a degree of rotation can correspond to a number of inputs from a mouse. In such an example, computer executable instructions stored in memory and operated by a processor can provide for the rotation tool to respond to a series of clicks from the mouse. In some embodiments, each click by the mouse can activate and/or manipulate the rotation tool to rotate a user interface a preset number of degrees, e.g. 1 click=10 degrees of rotation, 2 clicks=20 degrees, 3 clicks=30 degrees, and so on.

In other embodiments, using the I/O component can include using a mouse having a wheel. In such embodiments, rotation of one or more user interfaces can correspond to rotation of the wheel on the mouse. In another embodiment, using the I/O component can include using a mouse for controlling a mouse controlled cursor on the display. In such embodiments, rotation of one or more user interfaces can correspond to a movement of the mouse controlled cursor on the display. For example, a rotation tool on a user interface can be activated by clicking and holding a button on the mouse. The rotation tool can be manipulated to rotate the user interface by dragging the user interface to rotate the user interface with the mouse controlled cursor to a desired orientation on the display.

In some embodiments, an I/O component can include a keyboard. In such embodiments, a keystroke or keystrokes can be used to activate and manipulate the rotation tool. In some embodiments, a combination of I/O components can be used. For example, a mouse can be used to select a dialogue box, and a keyboard can be used to enter a value into the box.

FIG. 5B illustrates user interface 506 oriented from a first orientation 530 to a second orientation 532. The second orientation corresponds to the selected item on the pull-down menu that represents the 90 degree rotation.

In some embodiments, a user interface can be rotated in a clockwise and/or counter-clockwise direction. For example, as shown in FIG. 5B, the user interface 508 is shown as being rotated from the first orientation 530 to a second orientation 532 in a counter-clockwise direction 536.

The rotation tool can include a number of rotation options such as the selection of predetermined rotation increments entered by a user, and/or a pre-selected or entered direction of rotation. For example, the rotation tool can be preset to rotate in 20 degree increments. In such embodiments, the increment value can be entered by a user or can be predefined by computer executable instructions, for example. In some embodiments, the rotation tool can provide a pre-selected and/or user selectable clockwise and/or counter-clockwise rotation choice as indicated by icons 534 and 536.

Additionally, in some embodiments, the rotation can also be oriented in an into and/or out of the display orientation. As used herein, “into the display” can be defined as when the top of the user interface is directed into the display, and “out of the display” can be defined as when the top of the user interface is directed out of the display. These types of rotation can be useful in viewing three dimensional images, such as in computer aided drafting programs or in some types of games.

Although specific embodiments have been illustrated and described herein, it will be appreciated from this disclosure that any arrangement calculated to achieve the same techniques can be substituted for the specific embodiments shown. This disclosure is intended to cover any and all adaptations or variations of various embodiments of the present disclosure.

It is to be understood that the above description has been made in an illustrative fashion, and not a restrictive one. Combination of the above embodiments, and other embodiments not specifically described herein will be apparent upon reviewing the above description.

The scope of the various embodiments of the present disclosure includes any other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the present disclosure have to include more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device, comprising:
a memory having computer executable instructions to:
rotate selected ones of a plurality of user interfaces on a display without rotating unselected ones of the plurality of user interfaces.

2. The computing device of claim 1, wherein the computer executable instructions provide instructions such that each of the plurality of user interfaces can be used by a different user.

3. The computing device of claim 1, wherein one or more of the plurality of user interfaces includes a graphical user interface (GUI).

4. The computing device of claim 3, wherein the GUI includes one of: a gaming interface, a word processing interface, and a web browsing interface.

5. The computing device of claim 3, wherein the computer executable instructions further include instructions to provide a rotation tool that includes an icon on the GUI.

6. The computing device of claim 5, wherein the icon is located in an application window within the GUI.

7. The computing device of claim 1, wherein the computer executable instructions further include instructions to provide an item on a pull-down menu, and wherein rotating the one or more selected user interfaces, includes selecting the item.

8. The computing device of claim 7, wherein the item on the pull down menu is a predetermined degree of rotation.

9. The computing device of claim 1, wherein the computer executable instructions further include instructions to provide a dialogue box, and wherein rotating the one or more selected user interfaces includes entering a degree of rotation in the dialogue box.

10. The computing device of claim 1, wherein the computer executable instructions further include instructions to provide selection of multiple user interfaces of the plurality of user interfaces to be rotated.

11. The computing device of claim 1, wherein the computer executable instructions further include instructions to provide selection of all user interfaces of the plurality of user interfaces to be rotated.

12. The computing device of claim 1, wherein the one or more user interfaces of the plurality of user interfaces are provided on a touch screen display and wherein rotating one or more selected user interfaces includes contacting the touch screen.

13. The computing device of claim 1, wherein the computer executable instructions further include instructions to rotate the selected user interfaces based upon information provided by an I/O component.

14. The computing device of claim 13, where the I/O component includes a mouse, and wherein rotating the one or more selected user interfaces is directed based upon information received from the mouse.

15. The computing device of claim 14, wherein rotating the one or more selected user interfaces is directed based upon clicking a button on the mouse.

16. The computing device of claim 14, wherein rotating the one or more selected user interfaces is directed based upon rotating a wheel on the mouse.

17. The computing device of claim 14, wherein rotating the one or more selected user interfaces is directed based upon dragging a rotation tool using the mouse such that the dragging corresponds to a degree of rotation of the one or more selected user interfaces.

18. The computing device of claim 13, wherein the I/O component includes a keyboard, and wherein rotating the one or more selected user interfaces is directed based upon information received from the keyboard.

19. The computing device of claim 11, wherein the computer executable instructions further include instructions to rotate the selected user interfaces in three dimensions.

20. The computing device of claim 19, wherein the computer executable instructions further include instructions to rotate the selected user interfaces into the display, out of the display, and in the plane of the display.

21. A display system, comprising:
a display for displaying a number of user interfaces; and
a computing device including:
a memory having computer executable instructions to:
provide the number of user interfaces on the display;
provide one or more users an ability to use each of the number of user interfaces;
provide a rotation tool associated with a particular user interface within the number of user interfaces; and
rotate a particular user interface associated with the rotation tool based on a manipulation of the rotation tool.

22. The display system of claim 21, wherein adjusting includes rotating the particular user interface associated with the rotation tool.

23. The display system of claim 21, wherein the display includes a touch screen display and wherein the touch screen display can be used to manipulate the rotation tool.

24. The display system of claim 21, wherein the display system includes an I/O component for manipulating the rotation tool.

25. The display system of claim 21, wherein one or more of the number of user interfaces includes a gaming interface.

26. The display system of claim 25, wherein the gaming interface can be rotated to orient the gaming interface from a first user orientation to a second user orientation.

27. A display system for displaying an image, comprising:
a display for displaying a number of user interfaces;
a memory having computer executable instructions to:
provide the number of user interfaces on the display; and
provide one or more users an ability to use each of a number of user interfaces; and
provide a rotation tool associated with each of the number of user interfaces; and
means for rotating each of the number of user interfaces.

28. The display system of claim 27, wherein means for rotating includes manipulating a rotation icon associated with at least one of the number of user interfaces.

29. The display system of claim 27, wherein means for rotating includes manipulating a pull down menu associated with at least one of the number of user interfaces.

30. The display system of claim 27, wherein means for rotating includes manipulating the rotation tool to select a degree of rotation.

31. The display system of claim 27, wherein means for rotating includes manipulating the rotation tool to select a direction of rotation.

32. The display system of claim 31, wherein selecting the direction of rotation includes selecting a direction from the group including: a clockwise direction, a counter-clockwise direction, an into the display direction, and an out of the display direction.

33. A method of rotating a user interface, comprising:
rotating selected ones of a plurality of user interfaces on a display without rotating unselected ones of the plurality of user interfaces.

34. The method of claim 33, wherein rotating the selected user interfaces includes:
activating a rotation tool associated with a particular user interface of the number of user interfaces; and
manipulating the activated rotation tool to rotate the particular user interface.

35. The method of claim 34, wherein activating the rotation tool includes contacting a surface of a display at a location corresponding to a position of the rotation tool on the display.

36. The method of claim 34, wherein activating the rotation tool includes selecting the rotation tool with a cursor controlled I/O component.

37. The method of claim 34, wherein activating the rotation tool includes selecting a window representing a particular user interface.

38. The method of claim 34, wherein manipulating the activated rotation tool includes selecting a degree of rotation from a number of preset values.

39. The method of claim 34, wherein manipulating the rotation tool includes selecting a degree of rotation using an I/O component.

40. The method of claim 34, wherein manipulating the rotation tool includes entering a degree of rotation in a dialogue box of the rotation tool using an I/O component.

41. A computer readable medium having a set of executable instructions for causing a device to perform a method, comprising:
rotating one or more selected user interfaces of a plurality of user interfaces on a display without rotating unselected ones of the plurality of user interfaces.

42. The medium of claim 41, wherein rotating one or more of the selected user interfaces includes using an I/O component.

43. The medium of claim 42, wherein using the I/O component includes using a mouse having a wheel, and wherein rotation of the one or more user interfaces corresponds to rotation of the wheel.

44. The medium of claim 42, wherein using the I/O component includes using a mouse for controlling a mouse controlled cursor on the display, and wherein rotation of the one or more user interfaces corresponds to a movement of the mouse controlled cursor on the display.
